(19) United States
(12) Patent Application Publication
(10) Pub. No.: US 2015/0228226 A1
(43) Pub. Date: Aug. 13, 2015

(54) POWER-EFFICIENT STEERABLE DISPLAYS

(71) Applicant: NVIDIA Corporation, Santa Clara, CA (US)

(72) Inventors: David LUEBKE, Charlottesville, VA (US); Douglas LANMAN, Sunnyvale, CA (US)

(73) Assignee: NVIDIA Corporation, Santa Clara, CA (US)

(21) Appl. No.: 14/180,001

(22) Filed: Feb. 13, 2014

(51) Int. Cl. G09G 3/34; G02F 1/133; G09G 3/36; G02F 1/1335

(52) U.S. Cl. CPC G09G 3/3406; G02F 1/133603; G02F 1/13306; G09G 3/36; G09G 2330/022; G09G 2320/0653; G09G 2354/00

(57) ABSTRACT

A method for angularly varying backlight illumination of a backlit display device. The method comprises determining at least one subject position and angularly varying a backlight illumination of a displayed image. The backlight illumination is angularly varied based upon and directed towards a determined position of the at least one subject. The angularly varied backlight illumination of the displayed image reduces the backlight illumination of the displayed image that is visible outside of the determined position of the at least one subject.

### TECHNICAL FIELD

The present disclosure relates generally to the field of displays and more specifically to the field of display backlighting.

### BACKGROUND

Liquid-crystal displays (LCDs) in modern mobile devices account for a large fraction of the total power expenditure of a mobile device. A conventional LCD comprises an array of liquid crystals arranged in front of a light source (also known as a backlight). The backlighting is used because the LCD produces no light of its own, but instead transmits light with spatially varying attenuation. Such backlight illumination may be provided by any number of light sources (e.g., one or more linear arrays of light-emitting diodes (LEDs) along edges of the LCD display screen, or a two-dimensional array of LEDs behind the LCD display screen) illuminating the LCD from behind. Depending on a level of backlight illumination and an overall desired light level of the image to be displayed, the liquid crystals of the LCD can be adjusted for a desired level of transparency.

The power used to provide desirable backlight illumination for the LCD may account for half or more of the total power requirement in a typical mobile device. Reducing the power used by the display can have a major impact on battery life. Techniques for improving the power efficiency of displays can include dimming the display's illumination, turning off the display when a gaze-detection unit indicates a user is not attending to it, and dimming the backlight to a minimal level needed by the currently displayed content (which can be quite low, for example during a dark shot of a movie). For example, the power requirements for backlight illumination may be reduced by turning down the backlight illumination and correspondingly opening up the individual liquid crystals of the LCD (making them more transparent) to compensate. Therefore, rather than having to power a backlight at 100 percent illumination, while for a given brightest pixel on the display screen letting through only 50 percent of the light, the backlight illumination can be reduced to 50 percent and then the same given brightest pixel opened all the way (transparent) to compensate. However, further improvements to power efficiency are still desired, especially for improving the power efficiency of display illumination.

### SUMMARY OF THE INVENTION

Embodiments of the present invention provide solutions to the challenges inherent in efficiently backlighting a liquid-crystal display (LCD). In a method according to one embodiment of the present invention, a method for angularly varying backlight illumination for a display screen is disclosed. The method comprises determining at least one subject position and angularly varying a backlight illumination of a displayed image. The backlight illumination is angularly varied based upon a determined position of at least one subject. The angularly varied backlight illumination of the displayed image reduces the backlight illumination of the displayed image that is visible outside of the determined position of the at least one subject, thus saving power.

In an apparatus according to one embodiment of the present invention, an apparatus for angularly varying illumination for a display screen is disclosed. The display screen comprises an angular position sensor and an angular position adjuster. The angular position sensor is operable to determine a position of at least one subject. The angular position adjuster is operable to angularly vary an illumination of an image displayed by a display screen based upon a determined position of at least one subject. This angular variation may include reducing the illumination of the display image that is visible outside of the determined position of at least one subject.

### BRIEF DESCRIPTION OF THE DRAWINGS

Embodiments of the present invention will be better understood from the following detailed description, taken in conjunction with the accompanying drawing figures in which like reference characters designate like elements and in which:

FIG. 1A illustrates an exemplary top-down view of a computing device with a backlit display screen positioned for viewing by a plurality of observers in accordance with an embodiment of the present invention;

FIG. 1B illustrates an exemplary side-view of a computing device with a backlit display screen positioned for viewing by a plurality of observers in accordance with an embodiment of the present invention;

FIG. 2A illustrates a side-view of an exemplary light-emitting diode (LED) and lens arrangement for providing directional backlight illumination for a backlit display screen in accordance with an embodiment of the present invention

FIG. 2B illustrates a side-view of an exemplary LED and lens arrangement for providing a steerable backlight illumination for a backlit display screen in accordance with an embodiment of the present invention;

FIG. 2C illustrates a top-down view of an exemplary LED array providing a steerable backlight illumination for a backlit display screen in accordance with an embodiment of the present invention;

FIG. 3 illustrates a flow diagram, illustrating a computer implemented method for angularly steering backlight illumination for a backlit display device in accordance with an embodiment of the present invention; and

FIG. 4 illustrates a block diagram of an exemplary control system for steering backlight illumination for a backlit display device in accordance with an embodiment of the present invention.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Power-Efficient Steerable Displays:

Embodiments of the present invention provide a solution to the increasing challenges inherent in providing power efficient backlight illumination for backlit display devices. Various embodiments of the present disclosure provide steerable backlight illumination to dramatically improve backlight illumination efficiency. As discussed in detail below, the backlight illumination of a backlit display device may be angularly varied based upon a determined or estimated set of one or more viewer or subject positions. The angularly varied backlight illumination of the display device reduces the backlight illumination of a displayed image that is visible away from, or outside of, the determined position of the one or more viewers.

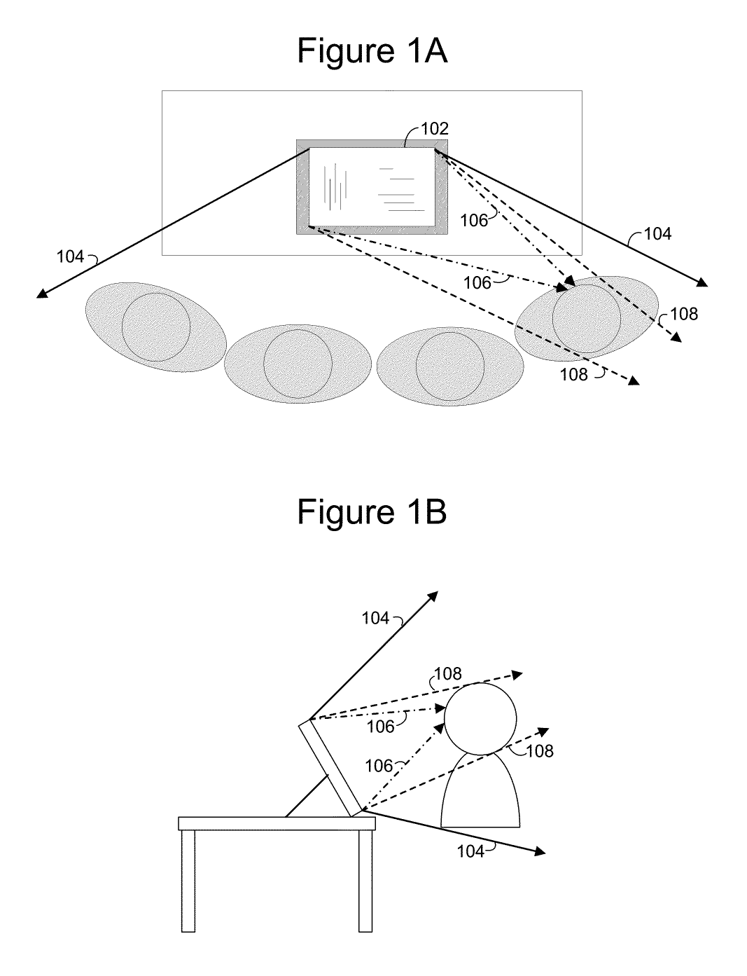

Embodiments of the present invention reduce the amount of power required by a display device by only illuminating certain directions. For example, the backlight illumination may be varied angularly, so that the backlight only illuminates in directions aimed towards the face or eyes of detected viewer(s). In one exemplary embodiment, as illustrated in FIGS. 1A and 1B, a display device 102 (e.g., as part of a tablet device, laptop computer, smart phone, or television) on a table is viewed by one or more users. As illustrated in FIG. 1A, an exemplary four users are viewing the display device 102. As illustrated in FIG. 1A, a wide percentage of the hemisphere in front of the display device 102 is illuminated by the backlight. An exemplary viewing angle 104 is illustrated in FIG. 1A. In another embodiment, the viewing angle is 180 degrees.

Given an exemplary hemisphere of backlight illumination, Table 1 illustrates what percentage of light leaving the display device 102 reaches the face or enters the pupils of the user. In one embodiment, represented by the viewing angle 106, far less than 1 percent of the emitted light enters a viewer's eyes. Even illuminating the entire face to relax accuracy and latency requirements on gaze tracking, represented by viewing angle 108, would require less than 4 percent of the illumination needed for the conventional wide viewing angles 104 (e.g., a hemispherical viewing angle). FIG. 1B provides a side-view of the above described viewing angles. As discussed herein, viewing angles 106 and 108 may also be applied to one or more of the additional viewers illustrated in FIG. 1A but are left off for the sake of clarity.

In one exemplary embodiment, a total solid angle per viewer, as a percentage of a total hemisphere above a display, is illustrated in Table 1. As illustrated in Table 1 and Figures lA &1B, if backlight illumination is exclusively steered toward known user(s) and not wasted by illuminating in other unneeded directions, such an illumination scheme may provide an optimal backlight process that dramatically reduces backlight illumination power requirements. As illustrated in Table 1, only a small fraction of the total energy expended to illuminate a display screen across a wide viewing angle (e.g., 180 degrees) ever reaches a viewer(s), let alone their eyes. Therefore, in exemplary embodiments of the present invention, backlight illumination may be angularly varied based upon a determined viewer position in front of the display device 102. As discussed herein, techniques may be used for tracking or estimating a location of a viewer's head or eyes and then making use of a display device of steerable backlight illumination to angularly control the backlight illumination so that only the viewer's head or eyes are illuminated.

The processes and embodiments discussed herein may be applied to any display based on a backlight and a spatial light modulator (SLM). Liquid crystal displays (LCDs) are (by far) the most commercially popular SLM, but not the only possible technology. Table 1 illustrates approximate possible efficiency improvements for handheld devices, desktop display devices, and conventional television screens. While the largest efficiency improvements may be found in steering backlight illumination to a viewer's eyes when watching a large television screen, efficiency improvements even for a handheld device held less than a meter from the user's eyes may still result in a dramatic efficiency improvement.

TABLE 1

| | Percentage solid angle of hemisphere | | |
|---|---|---|---|
| | needing illumination | | |
| | Distance to | | Distance to |
| | handheld | Distance to | 50″ Televi- |
| | device: | desktop: | sion Screen: |
| | 362 mm. | 635 mm. | 2000 mm. |
| Pupil size: 25 mm² | 0.00238% | 0.00078% | 0.00008% |
| Eyeball size: 625 mm² | 0.05961% | 0.01937% | 0.00195% |
| 95^{th} percentile face | 3.76937% | 1.23025% | 0.12425% |
| size: 39,767 mm² | | | |

### Exemplary Steerable Backlight Illumination Embodiments:

There are several possible embodiments, each of them providing some degree of narrow viewing angles with steerable or static backlight illumination based upon a determined or estimated viewer position, respectively. While for an active steerable backlight illumination scheme, an actual determined location of a viewer is necessary, for a passive steering backlight illumination scheme (where a set aiming point for the backlight illumination is utilized) an estimated viewer position may be used (based upon a most common viewer position).

In one embodiment, which may steer light in one dimension (e.g., horizontally or vertically), edge-arranged linear LED arrays are arranged with a wedge-shaped light guide, such that light rays from a particular string of LEDs bounce around and exit at a same angle. As discussed herein, exemplary embodiments may use the wedge-shaped light guide for steerable illumination to save power. For example, more discrete illumination directions or techniques for continuously varying the view direction, such as an exemplary wobbling light or an optical element with time-varying index-of-refraction, are described herein. In one exemplary embodiment, a one or more linear arrays of LEDs are arranged along edges of the display screen. This technique may be used for steering different images to different eyes (stereo viewing) and for steering backlights to different LCD color masks (field-sequential color). The selection of LEDs that are illuminated changes the direction of the light emitted from the lens above the light guide or light box, such that the light becomes steerable. As discussed herein, this technique may also be used to steer a same image to the eyes or faces of one or more subjects to reduce the power requirements of the display device 102.

Another exemplary embodiment may steer a single string of LEDs into the wedge at different angles by wobbling a mirror, or using LCDs to continuously vary index of refraction, etc., and illuminating the LEDs only at the moments when the resulting illumination will shine in the desired directions. In one embodiment, two different strings of LEDs are used to send light in two different directions, where each of these separate fields of view provide a different image (can be used for stereo viewing or viewing two different image contents), however, in another embodiment, each of the strings of LEDs is used to send a same image content to two different viewers and/or eyes. The one or more narrow viewing angles may be illuminated at a substantial energy savings when compared to wide viewing angle techniques.

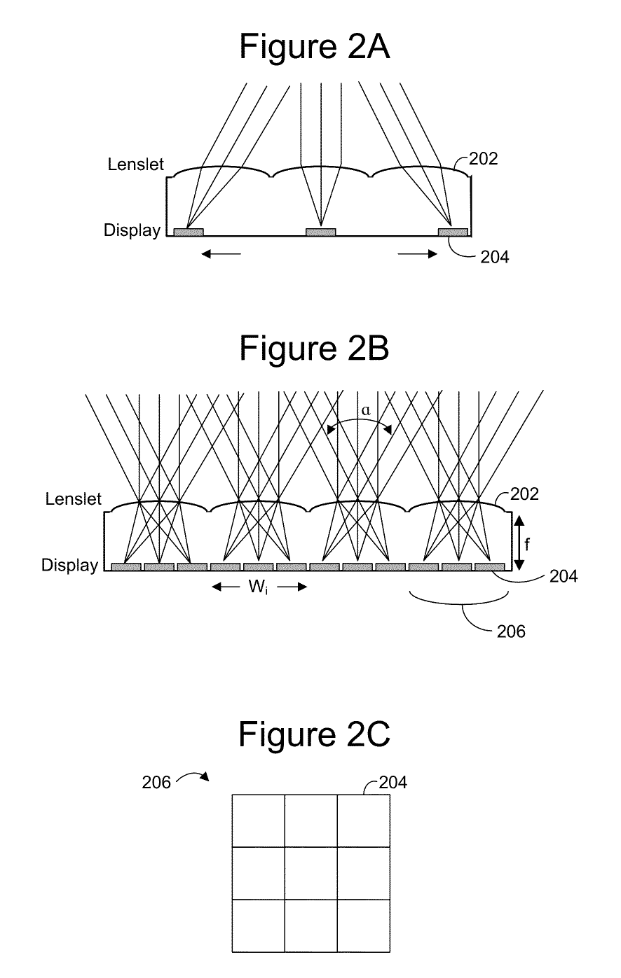

In one exemplary embodiment of a power-efficient steerable backlight illumination construction scheme for a display device, illustrated in FIGS. 2B and 2C, a microlens array 202 above a dense pixel grid (comprised of LEDs 204) may be used to create a light-field display. As illustrated in FIGS. 2B & 2C, each LED 204 may correspond to a light ray leaving the microlens 202 above it in a different direction. If the underlying display pixels are, for example, OLEDs 204, which only use power for the illuminated pixels (versus backlit displays such as LCDs), then the display will use less power when it is only illuminating rays along a particular direction. As illustrated in FIG. 2B, each LED 204 of a display typically emits light uniformly (isotropically) in all directions. When a microlens array is affixed to the display, light from a given LED is emitted along a narrow solid angle (anisotropically). The pitch (a) and focal length (f) of the microlens array 202 controls the trade-off between the spatial and angular resolution.

In one embodiment, to get directionality for a pixel 206, a lens 202 may be placed in front of an OLED 204, and based upon a position of the OLED 204 relative to the lens 202, a direction of light rays leaving the OLED 204 would be controlled. FIG. 2A illustrates three pixels, each with a single OLED 204 with a different position relative to the lens above it. As illustrated in FIG. 2A, the light rays from each OLED 204 will illuminate in a different direction. Therefore, based upon a focal length (f) of the lens 202, and a position of the OLED 204, a viewable image may be projected to be viewed by a viewer.

However, if the viewer is moving, the illuminated point will no longer be seen. Therefore, as illustrated in FIGS. 2B and 2C, the single OLED 204 may be replaced by an array of OLEDs 204 (note that each pixel comprises an array of OLEDs below a lens 202). Therefore, using an array of OLEDs 204 below the lens 202 of a pixel 206, individual OLEDs 204 may be turned on or off to allow illumination to reach a desired position. In other words, while there is an array of OLEDs 204 below the lens 202 for each pixel 206, only one OLED will be illuminated at a time for each desired direction of illumination (the desired directions corresponding to a user's eye, face, etc.). In one embodiment, to separately illuminate two eyes or the faces of two separate viewers, more than one OLED 204 for a given pixel 206 may be illuminated. Note that as discussed above, the position of the illuminated OLEDs 204 relative to the lens 202 determines the angle of the emitted light rays. In one embodiment, only one eye or one viewer receives the image at a time, with the illumination of the current image alternating between viewer eyes and/or different viewers. In one embodiment, as illustrated in FIGS. 2B and 2C, an array of 9 OLEDs for each pixel may be used, while other array configurations are also anticipated (e.g., 5×5, 10×10 arrays of OLEDs). In other words, the perceived image resolution may be a fraction of the actual image resolution of the OLED array below the lens 202, with a corresponding power savings. In another embodiment, the combination of OLEDs and microlens arrays described herein may be used to provide steerable illumination for the backlight of an LCD monitor, rather than forming the image directly. In this way, the image formed is at the full resolution of the LCD, while the OLED resolution and microlens parameters affect only the angular resolution of the selective backlight directions.

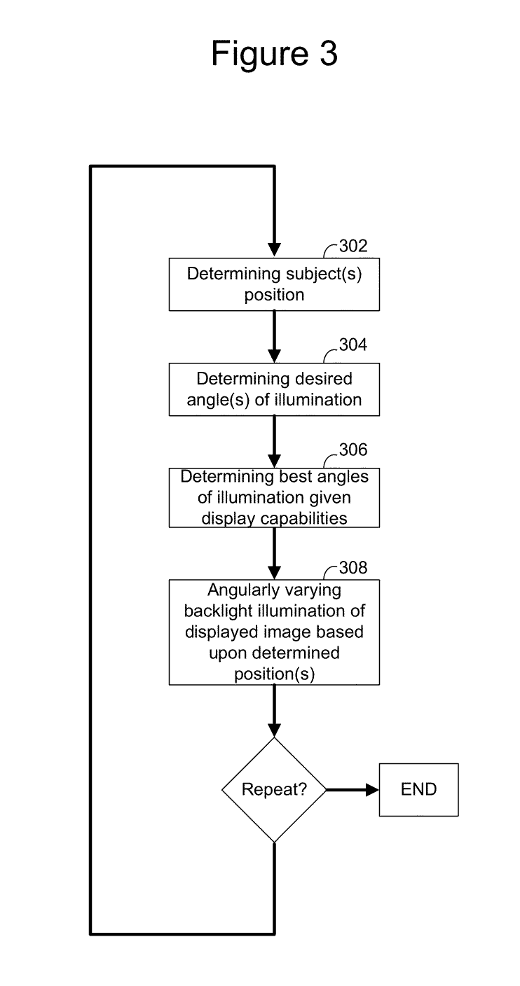

Therefore, as illustrated in FIG. 3, a computer implemented process for steering display illumination begins in step 302 of FIG. 3 by determining one or more viewer or subject's position. As discussed herein, the actual position of a viewer's head or eyes may be determined, or an estimate of the common location for a viewer's head or eyes may be used. In step 304 of FIG. 3, a desired angle(s) of illumination are determined. In step 306 of FIG. 3, best angles of illumination given a particular display's capabilities are determined. In step 308 of FIG. 3, the illumination of a display device 102 may be angularly varied in response to and directed toward the determined location of the viewer's head or eyes. As discussed herein, the illumination of the display device 102 may be backlight illumination for an LCD or illumination from individual OLEDs.

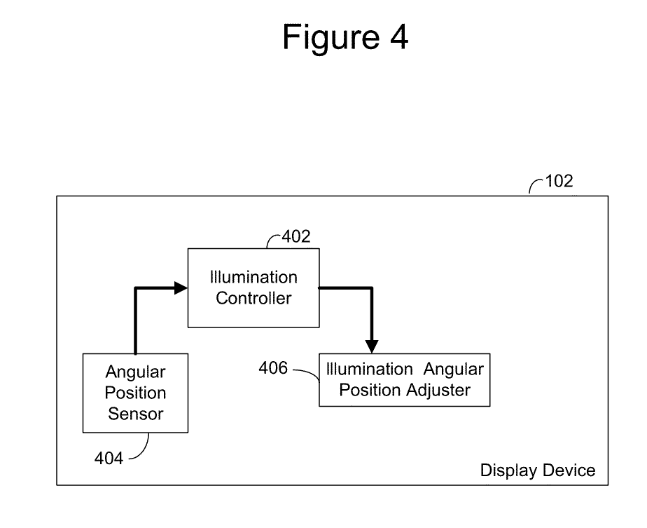

FIG. 4 illustrates a simplified block diagram of an illumination steering control system for a display device 102. As illustrated in FIG. 4, an angular position sensor 404 is used to detect the presence of one or more viewers and to determine a location of the one or more viewers. An illumination controller 402 receives the viewer position data from the angular position sensor 404. Using the viewer position data, the Illumination controller 402 determines which LED or OLED 204 to illuminate to allow an emitted light ray to reach a desired location. As illustrated in FIG. 4, the Illumination controller 402 directs the Illumination angular position adjuster 406 to switch selected LEDs or OLEDs 204 on or off to achieve a desired illumination from the display device 102. As discussed herein, depending on their individual position, relative to a lens above them, LEDs (in a linear array along an edge of a screen) or OLEDs (arranged in an array) may be individually turned on to select a desired directional, narrow viewing angle.

In one embodiment, steerable backlighting may be implemented using diffractive optics. A diffraction grating may be composed of a periodic optical structure (e.g., an array of elements with refractive, reflective, or light-absorbing elements). The composition of each element in the array may determine the degree to which light is scattered by the grating into each direction. So-called “holographic gratings” may allow fine-grained control of the light transmission and scattering properties and are suitable for forming steerable displays, but may necessitate narrowband illumination. Such gratings may consist of static optical features that are fabricated with fixed optical behaviors. Alternative, in another embodiment, active gratings may be fashioned dynamically using acousto-optic modulators (AOM), allowing the display to better adapt to moving viewers.

Note that any such display (with steerable backlighting or illumination) might need to support multiple viewers/eyeballs, and may also need to have a “fallback” mode where the display illuminates conventionally, in all directions evenly. In one embodiment, when two or more viewers are detected, a current, original viewer may be queried to determine if additional illumination steering should be utilized to allow the additional viewer(s) to see the displayed content. In other words, because of the steerable, narrow field of view, viewers outside the steerable field of view will not receive the illumination and will be unable to view the displayed content without the current viewer's permission.

Because additional viewers outside the current viewing angle are not able to easily view the displayed content, an additional benefit of steerable illumination includes viewer privacy. In accordance with embodiments of the present invention, when an illumination is steered to illuminate a viewer's face or eyes, another viewer out of the current field of view of the angularly steered illumination will see a darkened display screen and have difficulty in viewing the displayed image. Significant power savings over conventional privacy filters that merely absorb undesired illumination may also be realized.

### Additional Refinements of Steerable Illumination:

In one embodiment, in addition to a steerable illumination (e.g., backlight illumination for LCDs or illumination from OLEDs), the angularly varied illumination process is subjected to further refinements. For example, while the illumination may be globally dimmed as discussed herein, the illumination may also be spatially varied based upon a content of a currently displayed image. For example, when a portion of a displayed image on the display device 102 is darker than the rest of the image, the illumination of that portion of the dark image may be dimmed such that that portion of the illumination is spatially varied compared to the rest of the image's illumination.

Exemplary embodiments of the present invention contemplate the use of any steerable display illumination coupled with a method for detecting or estimating viewer eye and/or head position, for the benefit of reducing display power consumption as well as providing private viewing.

The above described reduction in power used by the display device 102 may have tremendous benefits on battery life for mobile devices, laptops, etc. It may also reduce the power required for larger displays, such as desktop computers and televisions. Such an arrangement may be important for enabling power-efficient, practical high-intensity television (current “high dynamic range” televisions may draw 1500 watts).

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A method for displaying an image using a display device, the method comprising:
determining at least one subject position viewing the display device;
angularly varying a backlight illumination of a displayed image on said display device based upon a determined position of the at least one subject, wherein angularly varying the backlight illumination of the displayed image comprises reducing the backlight illumination of the displayed image that is visible outside of the determined position of the at least one subject.

2. The method of claim 1, wherein the determined position of the at least one subject is a facial position of the at least one subject.

3. The method of claim 1, wherein the determined position of the at least one subject is a pair of ocular positions, and wherein a same angularly varied backlight illumination of the displayed image is displayed to both ocular positions of the at least one subject.

4. The method of claim 1, wherein the reducing the backlight illumination of the displayed image visible outside of the determined position of the at least one subject reduces the backlight illumination of the displayed image to a low threshold when viewing the displayed image outside of the determined position of the at least one subject.

5. The method of claim 1, wherein the reducing the backlight illumination of the displayed image visible outside of the determined position of the at least one subject reduces the backlight illumination of the displayed image sufficiently to substantially prevent viewing the displayed image outside of the determined position of the at least one subject.

6. The method of claim 1, wherein the at least one subject position comprises two or more subject positions, wherein a first subject position is angularly different from a second subject position, wherein a same backlight illumination of the displayed image is visible at the first subject position and the second subject position, and wherein each subject position is provided a different field of view.

7. The method of claim 1 further comprising spatially varying the angularly varied backlight illumination of the displayed image based upon a content of the displayed image.

8. A display apparatus comprising:
a display screen;
an angular position sensor operable to determine a position of at least one subject viewing the display screen;
an angular position adjuster operable to angularly vary an illumination of an image displayed by the display screen based upon a determined position of the at least one subject, wherein the angular position adjuster is further operable to angularly vary the illumination of the displayed image to reduce illumination of the image that is visible outside of the determined position of the at least one subject.

9. The display apparatus of claim 8, wherein the determined position of the at least one subject is a facial position of the at least one subject.

10. The display apparatus of claim 8, wherein the determined position of the at least one subject is a pair of ocular positions, and wherein the angular position adjuster is further operable to angularly vary a same displayed illumination of the displayed image to both ocular positions of the at least one subject.

11. The display apparatus of claim 8, wherein the angular position adjuster reduces the illumination of the displayed image visible outside of the determined position of the at least one subject to a low threshold when viewing the displayed image outside of the determined position of the at least one subject.

12. The display apparatus of claim 8, wherein the angular position adjuster reduces the illumination of the displayed image visible outside of the determined position of the at least one subject sufficiently to substantially prevent viewing the displayed image outside of the determined position of the at least one subject.

13. The display apparatus of claim 8, wherein the at least one subject position comprises two or more subject positions, wherein a first subject position is angularly different from a second subject position, wherein a same illumination of the displayed image is visible at the first subject position and the second subject position, and wherein each subject position is provided a different field of view.

14. The display apparatus of claim 8, wherein the angular position adjuster is further operable to dynamically spatially vary the angularly varied illumination of the displayed image based upon a content of the displayed image.

15. The display apparatus of claim 8, wherein the display device further comprises:
one of light-emitting diodes (LEDs) and organic light-emitting diodes (OLEDs);
a lens assembly above the LEDs and OLEDs; and
wherein the angular position adjuster is further operable to angularly vary the illumination of the displayed image by selectively turning on or off one of the LEDs and OLEDs for a backlit LCD display and OLED display, respectively, and wherein the selection is based upon a position of the individual LEDs or OLEDs relative to the lens above the individual LEDS or OLEDs.

16. An apparatus for angularly varying backlight illumination for a backlit display device, the apparatus comprising:
a display screen;
means for determining a position of at least one subject viewing the display screen; and
means for angularly varying a backlight illumination of an image displayed by the display screen based upon a determined position of the at least one subject, wherein the means for angularly varying the backlight illumination of the displayed image also reduces the backlight illumination of the image that is visible outside of the determined position of the at least one subject.

17. The display apparatus of claim 16, wherein the determined position of the at least one subject is a facial position of the at least one subject.

18. The display apparatus claim 16, wherein the determined position of the at least one subject is a pair of ocular positions, and wherein the means for angularly varying the backlight illumination comprises a means for angularly varying a same displayed backlight illumination of the displayed image to both ocular positions of the at least one subject.

19. The display apparatus of claim 16, wherein the means for reducing the backlight illumination of the displayed image visible outside of the determined position of the at least one subject to a low threshold when viewing the displayed image outside of the determined position of the at least one subject.

20. The display apparatus of claim 16, wherein the means for reducing the backlight illumination of the displayed image visible outside of the determined position of the at least one subject sufficiently to substantially prevent viewing the displayed image outside of the determined position of the at least one subject.

21. The display apparatus of claim 16, wherein the at least one subject position comprises two or more subject positions, wherein a first subject position is angularly different from a second subject position, wherein a same backlight illumination of the displayed image is visible at the first subject position and the second subject position, and wherein each subject position is provided a different field of view.

22. The display apparatus of claim 16 further comprising a means for dynamically spatially varying the angularly varied backlight illumination of the displayed image based upon a content of the displayed image.
